(19) United States
(12) Patent Application Publication
(10) Pub. No.: US 2017/0280700 A1
(43) Pub. Date: Oct. 5, 2017

(54) TACKLE ORGANIZER

(71) Applicant: Vernon D. Parker, Gilroy, CA (US)

(72) Inventor: Vernon D. Parker, Gilroy, CA (US)

(21) Appl. No.: 15/472,632

(22) Filed: Mar. 29, 2017

Related U.S. Application Data
(60) Provisional application No. 62/390,467, filed on Mar. 31, 2016.

(51) Int. Cl. A01K 97/08; A01K 97/06; B65D 81/18; B65D 41/04; B65D 21/02; B65D 25/54

(52) U.S. Cl. CPC A01K 97/08; B65D 21/0228; B65D 25/54; B65D 81/18; B65D 41/04; A01K 97/06

(57) ABSTRACT

Canisters are connected in a series configuration to form a tackle organizer. Each canister includes a bottom section, a base storage area, a top section and a barrier placed at a location where the base storage area is connected to the bottom section. The bottom section has an opening that has screw threads within the opening. The top section has an opening that allows access to the base storage area. The top section includes screw threads. A strap is connected to a first end of the tackle organizer and a second end of the tackle organizer. Canisters located in adjacent positions in the series configuration are attached together by screwing a top section of one canister into the opening of the bottom section of an adjacent canister.

### BACKGROUND

A tackle box is used by fisherman to keep fishing tackle and gear organized and protected.

### BRIEF DESCRIPTION OF THE DRAWINGS

FIG. 1 shows a tackle organizer in accordance with an embodiment.

FIG. 2 shows the tackle organizer of FIG. 1 with one canister opened in accordance with an embodiment.

FIG. 3 shows various parts of the tackle organizer of FIG. 1 in accordance with an embodiment.

FIG. 4, FIG. 5, FIG. 6, and FIG. 7 show details of different sized canisters of the tackle organizer of FIG. 1 in accordance with an embodiment.

### DETAILED DESCRIPTION

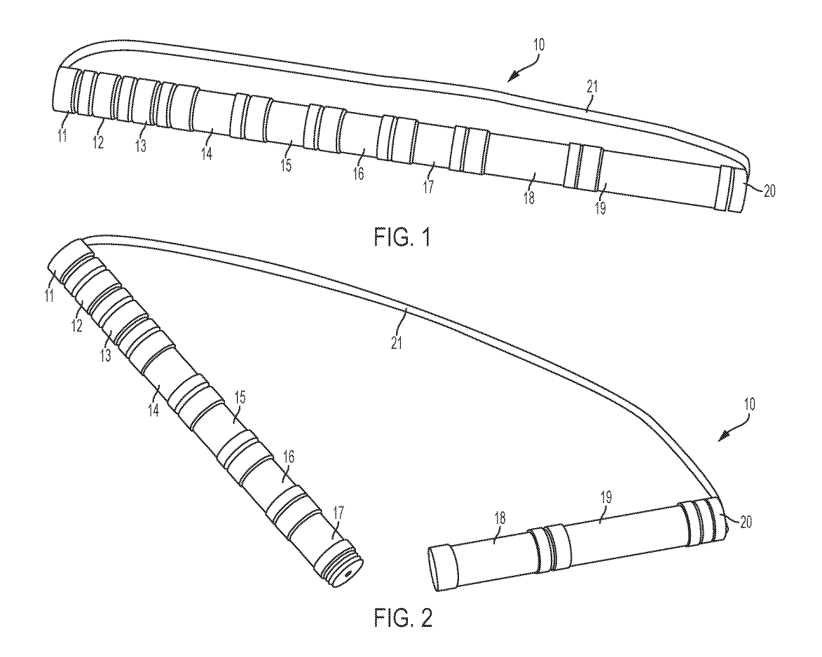

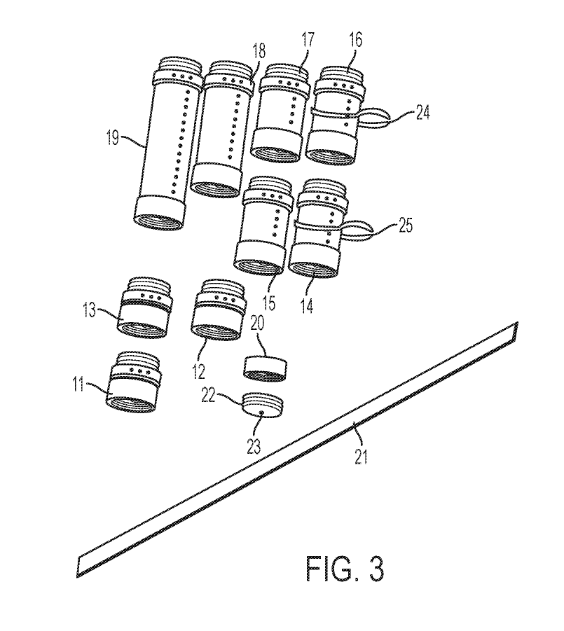

FIG. 1 shows an assembled tackle organizer 10. Tackle organizer 10 includes a canister 11, a canister 12, a canister 13, a canister 14, a canister 15, a canister 16, a canister 17, a canister 18, a canister 19, a cap 20 and a strap 21. The canisters are attached together, for example, using a helical structure such as screw threads. Strap 21 is connected to cap 20 at one end of tackle organizer 10. At the other end of tackle coordinator 10, strap 21 is attached to a plug 22 (shown in FIG. 3), screwed into the bottom of canister 11. For example, tackle organizer 10 and strap 21 are sized so that tackle organizer 10 can be carried comfortably by placing strap 21 over a shoulder of a user of tackle organizer 10.

FIG. 2 shows tackle organizer 10 configured so that canister 18 has been unscrewed from canister 17 allowing access to the storage area of canister 17. With canister 17 opened in this way, fishing tackle such as a lure, hooks, bait, a knife, weights, bobbers, plastic worms, grubs, sunscreen, plyers and so on can be loaded into or removed from canister 17.

FIG. 3 shows tackle organizer 10 disassembled. FIG. 3 shows the different sized canisters used to construct tackle organizer 10. Canister 19 is the largest canister, followed by canister 18. Canister 14, canister 15, canister 16 and canister 17 are all the same size. Likewise, canister 11, canister 12 and canister 13 are all the same size. For different implementations, different sized canisters can be used.

A small hole 23 within plug 22 is used to attach strap 21 to plug 22. For example, strap 21 is attached to plug 22 using a screw that is placed in hole 23. Likewise, strap 21 is attached to cap 20 using a screw or some other attachment device.

Optionally clips may be added to one or more of the canisters to allow a fishing pole to be attached to tackle organizer 10. For example, FIG. 3 shows clips 24 attached to canister 16 and clips 25 attached to canister 14 that are configured to attach a fishing poll to tackle organizer 10, allowing the fishing pole to be transported by the user as the user carries tackle organizer 10.

When reassembling tackle organizer 10, the canisters can be attached together in any order. Cap 20 and plug 22 are placed at opposite ends of tackle organizer 10 to allow attachment of strap 21 to both ends of tackle organizer 10. For example, strap 21 is made of leather, plastic, an elastic band or another material suitable for strapping tackle organizer 10 over a shoulder of a user of tackle organizer 10.

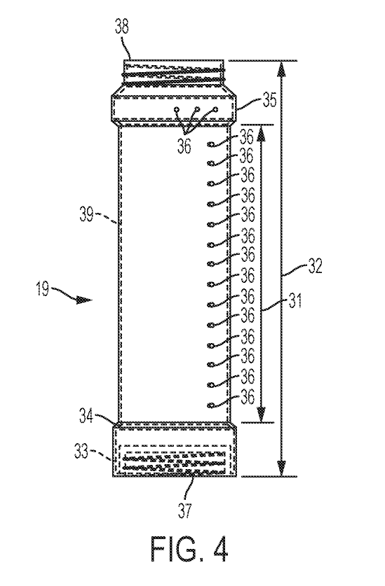

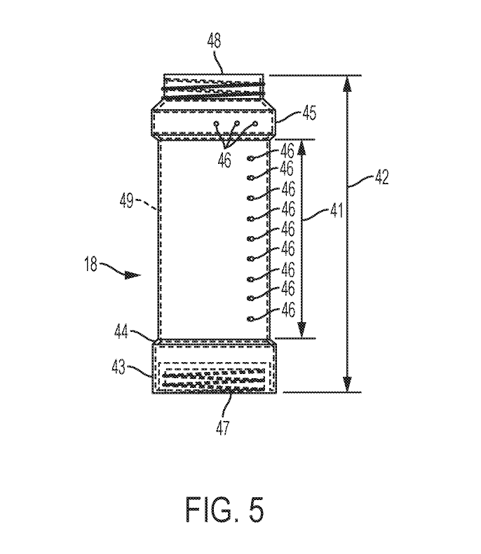

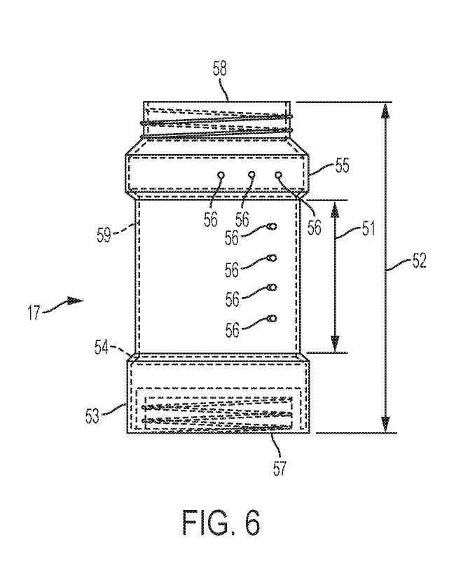

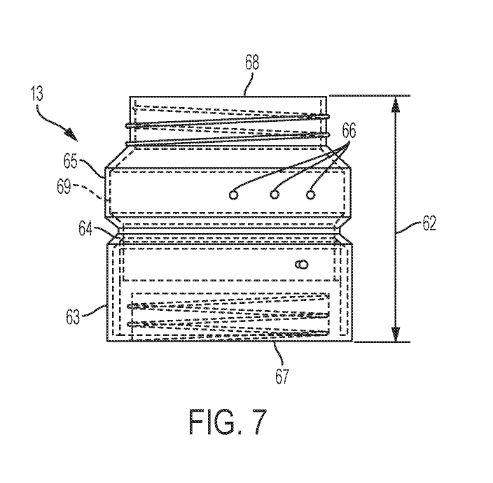

FIG. 4 shows additional details of canister 19. Canister 19 includes a base storage area 39. A top section 35 includes an external helical structure such as the shown screw threads which allow attachment to an adjacent canister or to cap 20. An opening 38, allows user access to base storage area 39. A bottom section 33 includes an internal helical structure such as the screw threads shown within an opening 37, allowing attachment to an adjacent canister or to plug 22. A barrier at location 34 serves as a bottom of storage area 39 that prevents contents stored in canister 19 from passing out of opening 37 of canister 19 into an adjacent canister attached below canister 19.

Air holes 36 provide ventilation for the contents of canister 19. For example, a length 31 of storage area 39 is approximately six inches and a length 32 of canister 19 is approximately eight and one half inches. For example, a diameter of canister 19 is between two and three inches. For example, canister 19 is made of clear plastic, allowing a user of tackle organizer 10 to view contents of canister 19 when tackle organizer 10 is assembled.

FIG. 5 shows additional details of canister 18. Canister 18 includes a base storage area 49. A top section 45 includes an external helical structure such as the shown screw threads which allow attachment to an adjacent canister or to cap 20. An opening 48, allows user access to base storage area 49. A bottom section 43 includes an internal helical structure such as the screw threads shown within an opening 47, allowing attachment to an adjacent canister or to plug 22. A barrier at location 44 serves as a bottom of storage area 49 that prevents contents stored in canister 18 from passing out of opening 47 of canister 18 into an adjacent canister attached below canister 18.

Air holes 46 provide ventilation for the contents of canister 18. For example, a length 41 of storage area 49 is approximately six inches and a length 42 of canister 18 is approximately eight and one half inches. For example, a diameter of canister 18 is between two and three inches. For example, canister 18 is made of clear plastic, allowing a user of tackle organizer 10 to view contents of canister 18 when tackle organizer 10 is assembled.

FIG. 6 shows additional details of canister 17. Canister 17 includes a base storage area 59. A top section 55 includes an external helical structure such as the shown screw threads which allow attachment to an adjacent canister or to cap 20. An opening 58, allows user access to base storage area 59. A bottom section 53 includes an internal helical structure such as the screw threads shown within an opening 57, allowing attachment to an adjacent canister or to plug 22. A barrier at location 54 serves as a bottom of storage area 59 that prevents contents stored in canister 17 from passing out of opening 57 of canister 17 into an adjacent canister attached below canister 17.

Air holes 56 provide ventilation for the contents of canister 17. For example, a length 51 of storage area 59 is approximately six inches and a length 52 of canister 17 is approximately eight and one half inches. For example, a diameter of canister 17 is between two and three inches. For example, canister 17 is made of clear plastic, allowing a user of tackle organizer 10 to view contents of canister 17 when tackle organizer 10 is assembled.

FIG. 7 shows additional details of canister 13. Canister 13 includes a base storage area 69. A top section 65 includes an external helical structure such as the shown screw threads which allow attachment to an adjacent canister or to cap 20. An opening 68, allows user access to base storage area 69. A bottom section 63 includes an internal helical structure such as the screw threads shown within an opening 67, allowing attachment to an adjacent canister or to plug 22. A barrier at location 64 serves as a bottom of storage area 69 that prevents contents stored in canister 13 from passing out of opening 67 of canister 13 into an adjacent canister attached below canister 13.

Air holes 66 provide ventilation for the contents of canister 13. For example, a length 61 of storage area 69 is approximately six inches and a length 62 of canister 13 is approximately eight and one half inches. For example, a diameter of canister 13 is between two and three inches. For example, canister 13 is made of clear plastic, allowing a user of tackle organizer 10 to view contents of canister 13 when tackle organizer 10 is assembled.

The foregoing discussion discloses and describes merely exemplary methods and embodiments. As will be understood by those familiar with the art, the disclosed subject matter may be embodied in other specific forms without departing from the spirit or characteristics thereof. Accordingly, the present disclosure is intended to be illustrative, but not limiting, of the scope of the invention.

What is claimed is:

1. A tackle organizer comprising:
a plurality of canisters connected in a series configuration, each canister comprising:
a bottom section with an opening that has screw threads within the opening,
a base storage area,
a top section with an opening that allows access to the base storage area, the top section including a screw threads, and
a barrier placed at a location where the base storage area is connected to the bottom section;
a cap screwed onto a top section of a first canister connected in a first position in the series configuration;
a plug screwed into the opening of the bottom section of a last canister connected in a last position in the series configuration; and,
a strap connected to the cap and to the plug;
wherein canisters located in adjacent positions in the series configuration are attached together by screwing a top section of one canister into the opening of the bottom section of an adjacent canister.

2. A tackle organizer as in claim 1 wherein all canisters in the plurality of canisters are made from clear plastic material.

3. A tackle organizer as in claim 1 wherein all canisters in the plurality of canisters include ventilation holes.

4. A tackle organizer as in claim 1 wherein a number and size of canisters in the plurality of canisters, and a length of the strap are chosen to allow strapping the tackle organizer over a shoulder of a user of the tackle organizer.

5. A tackle organizer as in claim 1 additional comprising:
clips attached to one or more of the canisters, the clips being configured to attach a fishing poll to the tackle organizer.

6. A tackle organizer as in claim 1 wherein some of the canisters in the plurality of canisters are different sizes that other canisters in the plurality of canisters.

7. A tackle organizer as in claim 1 wherein the strap is composed of leather.

8. A tackle organizer as in claim 1 wherein the strap is composed of elastic material.

9. A tackle organizer comprising:
a plurality of canisters connected in a series configuration, each canister being composed of clear plastic material, each canister being sized to contain fishing tackle and each canister comprising:
a bottom section with an opening that has screw threads within the opening,
a base storage area,
a top section with an opening that allows access to the base storage area, the top section including a screw threads, and
a barrier placed at a location where the base storage area is connected to the bottom section; and,
a strap connected to a first end of the tackle organizer and a second end of the tackle organizer;
wherein canisters located in adjacent positions in the series configuration are attached together by screwing a top section of one canister into the opening of the bottom section of an adjacent canister.

10. A tackle organizer as in claim 9 wherein all canisters in the plurality of canisters include ventilation holes.

11. A tackle organizer as in claim 9 wherein a number and size of canisters in the plurality of canisters, and a length of the strap are chosen to allow strapping the tackle organizer over a shoulder of a user of the tackle organizer.

12. A tackle organizer as in claim 9 additional comprising:
clips attached to one or more of the canisters, the clips being configured to attach a fishing poll to the tackle organizer.

13. A tackle organizer as in claim 9 wherein some of the canisters in the plurality of canisters are different sizes that other canisters in the plurality of canisters.

14. A tackle organizer comprising:
a plurality of canisters connected in a series configuration, each canister being sized to contain fishing tackle and each canister comprising:
a bottom section with an opening that has screw threads within the opening,
a base storage area,
a top section with an opening that allows access to the base storage area, the top section including a screw threads, and
a barrier placed at a location where the base storage area is connected to the bottom section;
a strap connected to a first end of the tackle organizer and a second end of the tackle organizer; and,
clips attached to one or more of the canisters, the clips being configured to attach a fishing poll to the tackle organizer;
wherein canisters located in adjacent positions in the series configuration are attached together by screwing a top section of one canister into the opening of the bottom section of an adjacent canister.

15. A tackle organizer as in claim 14 wherein all canisters in the plurality of canisters include ventilation holes.

16. A tackle organizer as in claim 14 wherein a number and size of canisters in the plurality of canisters, and a length of the strap are chosen to allow strapping the tackle organizer over a shoulder of a user of the tackle organizer.

17. A tackle organizer as in claim 14 wherein some of the canisters in the plurality of canisters are different sizes that other canisters in the plurality of canisters.

18. A tackle organizer as in claim 14 wherein all canisters in the plurality of canisters are made from clear plastic material.

19. A tackle organizer as in claim 14, additionally comprising:
a cap screwed onto the first end of the tackle organizer; and
a plug screwed into the second end of the tackle organizer;
wherein the strap is connected to the cap and to the plug.
